(19) United States
(12) Patent Application Publication
(10) Pub. No.: US 2013/0070609 A1
(43) Pub. Date: Mar. 21, 2013

(54) Ensuring Reception Quality for Non-Adjacent Multi-Carrier Operation

(71) Applicants: Johan Hultell, Solna (SE); Johan Bergman, Stockholm (SE); Namir Lidian, Solna (SE)

(72) Inventors: Johan Hultell, Solna (SE); Johan Bergman, Stockholm (SE); Namir Lidian, Solna (SE)

(73) Assignee: Telefonaktiebolaget LM Ericsson (publ)

(21) Appl. No.: 13/499,721

(22) PCT Filed: Mar. 23, 2012
(86) PCT No.: PCT/SE12/50325

§ 371 Date: Apr. 17, 2012

Related U.S. Application Data
(60) Provisional application No. 61/469,971, filed on Mar. 31, 2011.

(51) Int. Cl. H04W 36/06; H04W 24/02

(52) U.S. Cl. 370/241

(57) ABSTRACT

User equipment (1100, 1200) supporting multi-carrier operation is adapted to identify whether it is experiencing an excessive interference level on a downlink carrier, which interference may be due to an aggressor carrier. Based on this information, the user equipment deactivates one or more of the downlink carriers so that an adequate downlink quality can be maintained for at least some of the carriers. In an example method, a plurality of activated downlink carriers including at least two non-adjacent downlink carriers in a frequency band are received (1010). The user equipment monitors (1020) quality of at least a subset of the plurality of activated downlink carriers, and determines (1030) that the quality of at least one of the monitored carriers is worse than a predetermined threshold. In response, the user equipment deactivates (1040) one or more of the activated downlink carriers.

### RELATED APPLICATION

This application claims the benefit of U.S. Provisional Patent Application 61/469,971, filed 31 Mar. 2011.

### TECHNICAL FIELD

The present invention relates generally to carrier aggregation in a mobile communication system and, more particularly, to mitigating interference caused to non-adjacent carriers from interfering carrier signals.

### BACKGROUND

Carrier aggregation is one of the new features recently developed by the members of the 3rd-Generation Partnership Project (3GPP) for both High-Speed Downlink Packet Access (HSDPA) systems and so-called Long Term Evolution (LTE) systems. In particular, 3GPP Releases 8, 9, and 10 introduced support for multi-cell downlink transmissions for HSDPA.

More specifically, in Release 8 Dual-Cell HSDPA (DC-HSDPA) operation was introduced where the Node-B can schedule simultaneous transmissions on two adjacent downlink carriers to a single user equipment (UE). This is shown in the top portion of FIG. 2. In Release 9, support for DC-HSDPA in combination with MIMO (Multiple-Input Multiple-Output) transmissions as well as Dual-Band DC-HSDPA was introduced. DC-HSDPA in combination with MIMO provides a peak data rate of 84 Mbps, while Dual-Band DC-HSDPA extends the Release 8 DC-HSDPA feature so that the two configured downlink carriers can be located in different frequency bands, e.g., as shown in the middle portion of FIG. 2. In Release 10, 4C-HSDPA operation was specified. 4C-HSDPA provides peak data rates of 168 Mbps and the four configured carriers can be spread across at most two frequency bands, as shown in the bottom portion of FIG. 2. However, all configured carriers within a frequency band need to be adjacent. Currently, 3GPP is in the process of specifying support for 8C-HSDPA in Release 11. 8C-HSDPA will allow peak data rates up to 336 Mbps. As in Release 10, the carriers can be spread across two frequency bands and all configured carriers within a band need to be adjacent.

Heretofore all downlink multi-carrier features specified in 3GPP have been restricted to scenarios where all configured carriers within a band are adjacent. For Release 8 and Release 9 operation where the system bandwidth that is allocated to one particular UE is at most 10 MHz this is not a severe limitation, since it only concerns two adjacent carriers. However, for Release 10 and Release 11 which support system bandwidths of 20 to 40 MHz, respectively, it becomes increasingly likely that the carriers belonging to a particular operator in a band are non-adjacent.

To fully benefit from multi-cell HSDPA operation over large bandwidths it is thus necessary to also support non-contiguous carrier configurations within a band. An example of such a configuration is illustrated in FIG. 3, where carriers f1 and f3 are in Band I, but are separated by space for one or more other carrier frequencies. In Release 10, the serving Node-B can deactivate secondary serving HS-DSCH (High Speed Downlink Shared Channel) cells using HS-SCCH (High Speed Shared Control Channel) orders so that the activated carriers are non-adjacent. However, the RRC (Radio Resource Control) Layer 3 configured carriers are still adjacent, although some of them may be temporarily deactivated from a Layer 1/Layer 2 point of view. This is illustrated in FIG. 5, where carriers f1, f2, f3, and f4 are configured for a given UE, but carrier f2 is deactivated, as indicated by the dashed outline.

It should be noted that the terminology used to describe multi-carrier operation in 3GPP continues to evolve, and may also differ in non-3GPP contexts. As used herein, the terms “carrier” and “cell” are generally meant to be interchangeable, unless the context clearly indicates otherwise. While in some contexts the term “carrier” refers to the physical signal that carries the signaling and/or data services provided by a “cell,” that distinction is not important for the discussion that follows. It should also be noted that the term “frequency,” particularly in the uplink context, is sometimes used within 3GPP to refer to the carrier frequency on which the signaling and/or data services associated with a cell are transmitted. Accordingly, the present document and other literature describing multi-carrier operation will refer to “configured carriers,” “configured cells,” and/or “configured frequencies,” which in each case refers to whether a particular UE capable of multi-carrier operation has received all the necessary signaling and control information necessary for it to transmit or receive data on that cell/carrier/frequency. Likewise, the terms “activated cell,” “activated carrier,” and “activated frequency” refer to cells/carriers/frequencies that are not only configured for a given UE but that are also designated by the system as “active,” in the sense that they should be monitored by the UE (in the case of downlink carriers) or are immediately available for use in uplink transmissions.

The main difference between scenarios where the configured carriers are required to be adjacent and scenarios where the carriers are non-contiguous arises from the fact that interference level from carriers that appear between non-adjacent configured carriers is both unknown and uncontrollable for the network, since these carriers may be used by another operator with a different network deployment. Due to practical restrictions in the filters used by the UE when receiving data carriers that are configured in a non-adjacent manner, leakage from “aggressor” carriers, which are not targeted to a particular UE, onto the victim carriers used by the UE results in interference at the UE. This interference can be at levels severe enough that the radio quality for the victim carriers becomes so low so that the UE cannot even demodulate the control and data channels. Accordingly, techniques for controlling and/or mitigating such interference are needed.

### SUMMARY

Several embodiments of the invention described herein enable a given UE to identify whether it is experiencing an excessive interference level on a downlink carrier, which interference may be due to an aggressor carrier. Based on this information, the UE deactivates one or more of the downlink carriers so that an adequate downlink quality can be maintained for at least some of the carriers. In some of these embodiments the UE measures downlink quality of a subset of the carriers; if the UE detects inferior quality for a given time period then the UE deactivates the one or more carriers. Upon deactivating a secondary carrier the UE may inform the network upon the taken action to increase the robustness.

One approach according to the present invention is carried out by the UE and is applicable to a scenario in which a UE is monitoring several carriers, including at least two activated non-adjacent carriers. In some embodiments of this approach there is a set of secondary serving HS-DSCH cells that the UE can deactivate without receiving an HS-SCCH order or RRC reconfiguration from the network (Node-B and RNC respectively). This set can either be hard-coded in the standard (e.g., all configured secondary serving HS-DSCH cells) or signaled explicitly by the RNC (e.g., via a bitmap). When evaluating whether and in such case which of the active configured secondary serving HS-DSCH cells should be deactivated, the UE monitors the quality of a set of HS-DSCH cells. Note that the monitored set can be different from the set of downlink carriers that the UE can deactivate. This monitored set is also referred to as the measured set.

If the quality for one or more of the downlink carriers belonging to the measured set is poor, then the UE deactivates one or more of the secondary serving HS-DSCH cells. For instance, the UE might deactivate all secondary serving HS-DSCH cells in the band where non-adjacent carriers exist. This approach has the advantage that the UE can now rely on receiver filters with smaller bandwidth, thus reducing the interference leakage from the potential aggressor carrier.

While several of the inventive techniques disclosed herein are described in the context of an HSDPA system, the techniques are more generally applicable. For example, an example method according to some embodiments of the invention is implemented in a user equipment supporting downlink multi-carrier operation. The method begins with the receiving of a plurality of activated downlink carriers, the activated downlink carriers including, in a frequency band, at least two non-adjacent downlink carriers that are separated by at least one aggressor carrier that the user equipment is not configured to receive. The user equipment monitors quality of at least a subset of the plurality of activated downlink carriers and determines that the quality of at least one of the measured set is worse than a predetermined threshold. In response, the user equipment deactivates one or more of the activated downlink carriers.

The monitoring of the quality can be based on one or several criteria, such as Channel Quality Indicator (CQI) measurements, a fraction of detected downlink packets (relative to the total downlink packets), a fraction of negative acknowledgements (NACKs) transmitted (relative to all acknowledgements transmitted), and a quality for a fractional dedicated physical channel (F-DPCH).

As noted, the deactivation of a carrier may be triggered by determining that the quality is worse than a predetermined threshold. In some embodiments, this predetermined threshold is received from a network node. In some embodiments, a receiver filter bandwidth is reduced in response to said deactivating, thus reducing the impact of the aggressor carrier on activated carriers.

The carriers monitored by the user equipment may include all or some of the plurality of activated downlink carriers, and thus may or may not include the at least two non-adjacent downlink carriers. In some embodiments, the activated downlink carriers include a set of secondary serving HS-DSCH cells that the user equipment can deactivate without receiving an HS-SCCH order or RRC reconfiguration, and the cell or cells deactivated by the user equipment are members of this set. This set may be all or some of the configured secondary serving HSDSCH cells. In some embodiments, the user equipment may first receive information identifying a set of downlink carriers that can be deactivated, in which case the deactivated downlink carrier or carriers are taken from the identified set.

In some embodiments, the user equipment explicitly signals the network that one or more carriers have been deactivated. For example, the user equipment may transmit an all-zero CQI in a position where CQI for a deactivated carrier would be transmitted if the carrier were activated.

In addition to the methods summarized above and described in further detail below, embodiments of the invention further include user equipment adapted to carry out these methods or variants thereof. An example user equipment is adapted to support downlink multi-carrier operation and includes means for receiving a plurality of activated downlink carriers, where the activated downlink carriers include, in a frequency band, at least two non-adjacent downlink carriers that are separated by at least one aggressor carrier that the user equipment is not configured to receive. This example user equipment further includes means for monitoring quality of at least a subset of the plurality of activated downlink carriers, means for determining that the quality of at least one of the measured set is worse than a predetermined threshold, and means for deactivating one or more of the activated downlink carriers, in response to this determining.

Of course, the present invention is not limited to the above-summarized features and advantages. Other techniques and apparatus for detecting when a UE is experiencing interference from an aggregator cell when the activated victim carriers are non-contiguous are described in detail below. Some of these embodiments provide for detecting when a UE would experience interference from an aggregator cell if the UE were to activate a secondary serving HS-DSCH cell. In several of these embodiments, steps are taken so that at least one of the configured active downlink carriers is ensured to have a sufficiently high quality (e.g. SIR) for receiving control and physical channels. The various aspects of the invention described herein thus provide improved performance, robustness and feasibility of multi-carrier operation in deployments where non-adjacent carriers are allocated to UEs, and those skilled in the art will recognize additional features and advantages of the invention upon reading the following detailed description and upon viewing the accompanying drawings.

### BRIEF DESCRIPTION OF THE DRAWINGS

FIG. 1 illustrates a scenario in which a multi-carrier user equipment (UE) receives interference from an aggressor carrier.

FIG. 2 illustrates several multi-carrier configurations specified by Releases 8, 9, and 10 of 3GPP specifications.

FIG. 3 illustrates a multi-carrier configuration which includes two non-adjacent activated carriers in a first band and a third activated carrier in a second operating band.

FIG. 4 illustrates a multi-carrier scenario where two non-adjacent carriers in a first band are configured, but one is deactivated.

FIG. 5 illustrates another multi-carrier scenario where the user equipment is configured with three adjacent carriers within one band, one of which is deactivated, and one carrier in another band.

FIG. 6 illustrates one example of the interference arising from a multi-carrier scenario.

FIG. 7 illustrates an example of the interference arising from a multi-carrier scenario in a heterogeneous cell deployment.

FIG. 8 illustrates a multi-cell configuration in which two non-adjacent carriers are configured in a given band.

FIG. 9 illustrates a multi-cell configuration in which two non-adjacent carriers are configured in a given band, but one is deactivated.

FIG. 10 is a process flow diagram illustrating an example method according to some embodiments of the invention.

FIG. 11 illustrates an example user equipment configured according to some embodiments of the invention.

FIG. 12 is another illustration of an example user equipment configured according to some embodiments of the invention.

### DETAILED DESCRIPTION

Several embodiments of the invention described herein enable a given UE to identify whether it is experiencing an excessive interference level on a downlink carrier, which interference is potentially due to an aggressor carrier. Based on this information, the UE deactivates one or more of the downlink carriers so that an adequate downlink quality can be maintained for at least some of the carriers. In some of these embodiments the UE measures downlink quality of a subset of the carriers; if the UE detects inferior quality for a given time period then the UE deactivates the one or more downlink carriers. Upon deactivating a secondary carrier the UE may inform the network upon the taken action to increase the robustness.

Although the invention is primarily described herein in the context of WCDMA/HSDPA, the inventive techniques disclosed herein are equally applicable to LTE (Long Term Evolution). Also, many of the concepts presented herein are applicable to settings where the network configures a UE with multiple non-adjacent uplink carriers in the same band. In this case the measurements and judgment of the interference due to an ‘aggressor carrier’ can be done at the Node-B side and will further depend on which UEs were active (scheduled) on the aggressor uplink carrier.

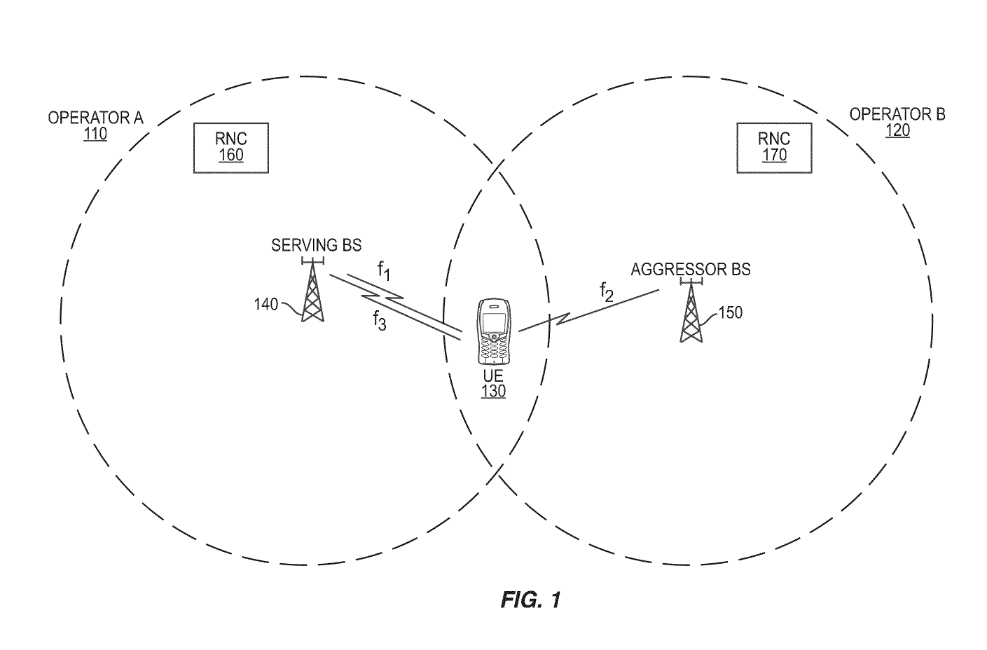

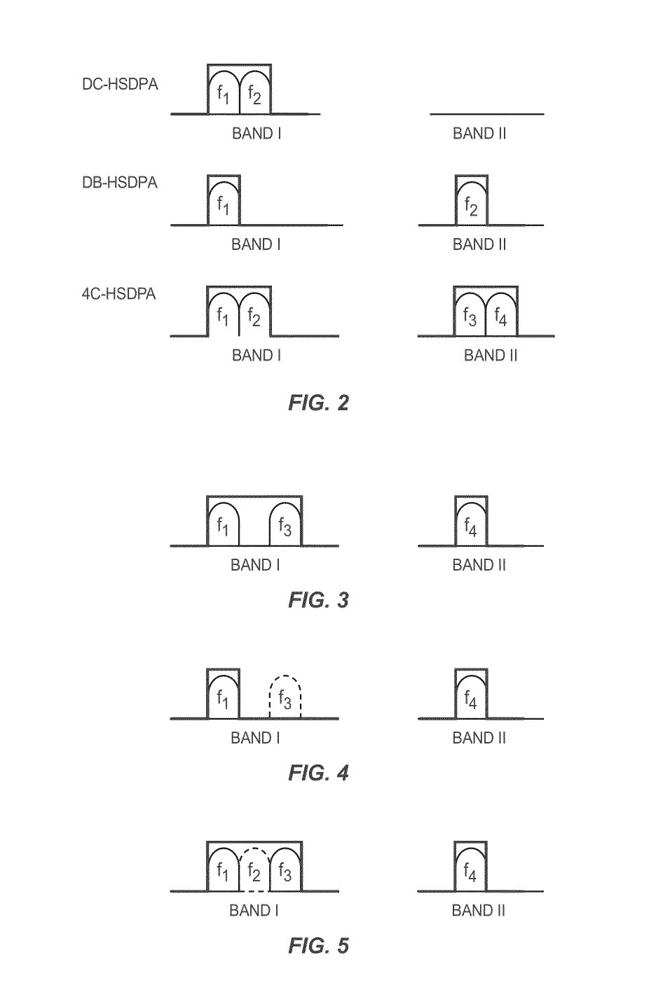

Referring now to the drawings, FIG. 1 illustrates an exemplary scenario that might be encountered by wireless mobile terminals, which are referred to as “user equipment” or “UEs” in 3GPP terminology. One UE 130 is shown in the simplified system illustrated in FIG. 1. UE 130 may be, for example, a cellular telephone, a personal digital assistant, a smart phone, a laptop computer, a handheld computer, or other device with wireless communication capabilities. In the scenario illustrated in FIG. 1, UE 130 is served by serving base station (BS) 140 which is associated with radio network controller (RNC) 160 and Operator A 110. As can be seen in the illustration UE 130 is capable of multi-carrier operation and is configured for operation with carrier f1 and carrier f3.

UE 130 is also operating in the vicinity of “aggressor” BS 150, which is associated with RNC 170 and Operator B 120. Aggressor BS 150 is transmitting on carrier f2, which is not intended for use by UE 130 but falls between carriers f1 and f3.

The terms “aggressor carrier” or “aggressor cell” as used herein refer to a cell that may cause excessive interference levels to a UE configured on a set of different carriers. These carriers are referred to as “victim carriers” or “victim cells” herein. In FIG. 1, carrier f2 is potentially an aggressor carrier, while carriers f1 and f3 are potential victim carriers.

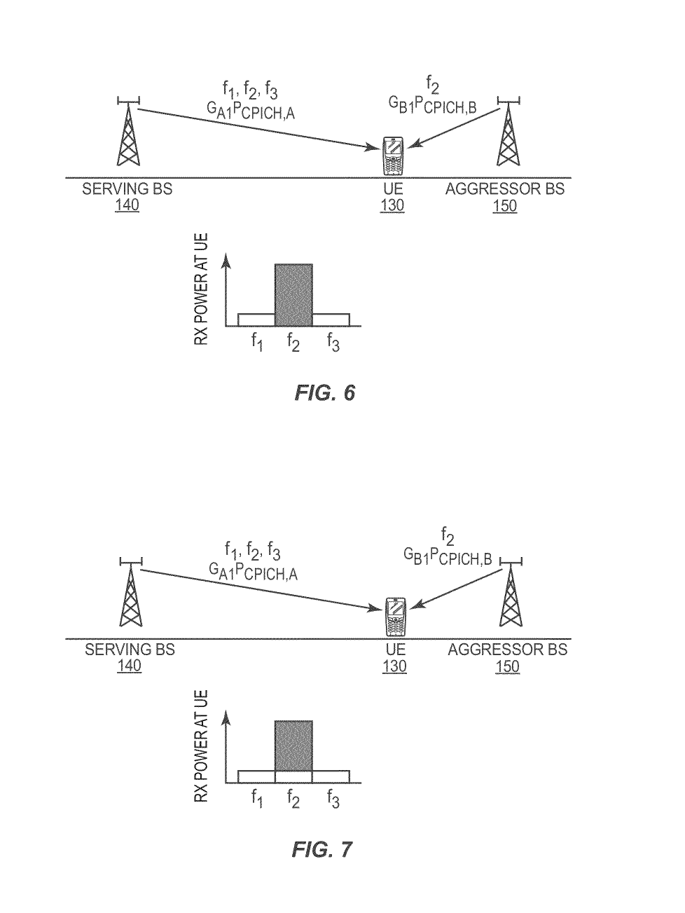

FIG. 6 illustrates in more detail an example scenario where this problem may occur. In particular, this will be the case when the UE utilizes one RF filter for each band (or more specifically when the number of receiver chains in the UE (NRx) are fewer than the number (Nc) of non-adjacent carriers that are activated, i.e., NRx<Nc.

In this example, the SIR (signal-to-interference ratio) that that UE experiences for cell f1 can be written as:

$${Γ}_{f 1} = \frac{{G}_{f 1} {P}_{f 1}}{{I}_{f 1} + {γ}_{f 3 \to f 1} {G}_{f 3} {P}_{f 3} + {γ}_{f 2 \to f 1} {G}_{f 2} {P}_{f 2} + N} , \qquad ( 1 )$$

where I_{f1} denotes the interference from f1, N denotes the noise power, γ_{f3→f1}G_{f3}P_{f3} denotes leakage from f3 onto f1 and γ_{f2→f1}G_{f2}P_{f2} denotes the leakage from f2 onto f1. If γ_{f2→f1}G_{f2}P_{f2}≧G_{f1}P_{f1} then Γ_{f1} may become very low. The same line of reasoning as presented for f1 also applies for carrier f3.

A similar problem can occur in heterogeneous network deployments where the macro layer is complemented by a micro layer on one of the frequencies f2. This scenario is illustrated in FIG. 7. From the standpoint of interference the scenario of FIG. 7 is similar to that of FIG. 6 except that UE 130 is also configured to receive f2. For Releases 8, 9, and 10, downlink multi-cell HSDPA operation all cells need to be transmitted from the same site (with the same timing). In this scenario the same operator controls all frequencies, e.g., f1, f2, f3, including the transmission of f2 from the aggressor BS 150. Accordingly, there are possibilities to avoid the problem, such as by never configuring multi-cell operation for certain cells in a given heterogeneous network deployment or by reconfiguring the UE based on existing mobility events. For instance, if Event 1a for the small cell operating on f2 occurs, this can be used by the RNC (Radio Network Controller) to reconfigure the UE.

For certain UE configurations there can be situations where the downlink quality of all downlink carriers allocated to the UE in a band becomes so poor that it is not possible to send data or control information on any of the downlink carriers to the UE in one or all of the configured bands. Under such conditions, it might be impossible to transmit L1 control channels, such as HS-SCCH orders for (de)activating secondary HS-DSCH cells, or L3 control messages, which are mapped onto the physical data channels. In this situation there will not be any possibility for the network to ensure that the radio quality of any of the downlink carriers is adequate, resulting in radio link failure.

As mentioned above, MC-HSPA operation was originally introduced in Release 8. HS-SCCH orders, which allow the serving Node-B to dynamically deactivate the secondary HS-DSCH cell(s) were also introduced at this time. The main purpose with deactivating and activating the secondary HS-DSCH cell(s) is to allow the Node-B to adapt the number of downlink carriers a given UE monitor and to adapt and the HS-DPCCH format. This is done with MAC-level signaling, i.e., without involving the RNC, so it can be performed more quickly than configuration of carriers, which requires Radio Resource Control (RRC) signaling. This allows the UE to achieve battery savings, especially during intervals of low data activity, by deactivating secondary serving HS-DSCH cells when they are not immediately needed. This is particularly useful if the carriers are located in different bands and the HS-SCCH deactivation orders result in all carriers within a band becoming deactivated so that the UE can entirely disable one of its receiver chains. An HS-DPCCH coverage similar to that of (legacy) single-carrier operation can likewise be achieved.

For Release 9 DC-HSUPA was introduced. With DC-HSUPA the serving Node-B can activate and deactivate the secondary uplink frequency by HS-SCCH orders. One of the main additional reasons for introducing HS-SCCH orders for DC-HSUPA was to ensure that the coverage of a UE configured with DC-HSUPA can be similar to that achieved with legacy single-carrier HSUPA operation. For both the MC-HSDPA and DC-HSUPA, it can be determined based on several criteria whether secondary serving HS-DSCH cells and/or secondary uplink frequency should be activated/deactivated. For MC-HSDPA these activation/deactivation decisions are in general based on the amount of data available at the serving Node-B for the particular UE (this can be used to identify buffer limited scenarios) and the CQI (Channel Quality Indicator) information associated with the activated downlink carriers and/or UE power headroom (UPH) information. CQI and UPH can be used to identify situations where the UE has poor coverage. For DC-HSUPA, activation/deactivation decisions can be based on the amount of data available in the UE buffer (available in the serving Node-B via the Scheduling Information (SI)) and the coverage available to the serving Node-B, which can determined from the UPH transmitted in the SI.

One particular area where work has been done to identify when to deactivate secondary serving HS-DSCH cells and/or secondary uplink frequency addresses the scenario when a UE is configured with DC-HSUPA in combination with MC-HSDPA. When multiple carriers are activated for both the uplink and downlink, it can be shown that even though the duplex distance for each pair of uplink and downlink carriers (i.e., the frequency distance between the serving HS-DSCH cell and the primary uplink frequency and the secondary serving HS-DSCH cell and the secondary uplink frequency) is the same as in legacy (single-carrier) operation, the effective duplex distance when both uplink and both downlink carriers are activated is reduced (e.g., by 5 MHz). Due to imperfections in the UE transmitter, which has spurious output transmission limits determined, e.g., by ACLR (Adjacent Channel Leakage Power Ratio) requirements, the UE uplink transmissions can cause self-interference to the downlink reception. This reduces the downlink coverage and can be detected by the Node-B, e.g., by monitoring the CQIs reported by the UE. If this situation is detected, the serving Node-B can deactivate the secondary uplink carrier so that the effective duplex distance becomes the same as if the UE was configured in single-carrier (legacy) operation.

In any case, it is desirable for the network (Node-B or RNC) or the UE itself to detect that a given UE is experiencing high interference levels from aggressor cells so that action can be taken before the quality becomes too bad. It is also desirable for the network (Node-B or RNC) and/or the UE to take any possible actions to ensure that the quality of at least one downlink carrier is adequate.

One approach according to the present invention is carried out by the UE, such as the UE 130 in FIG. 1, and is applicable to a scenario in which a UE is monitoring several carriers, including at least two activated non-adjacent carriers. In some embodiments of this approach there is a set of secondary serving HS-DSCH cells that the UE can deactivate without receiving an HS-SCCH order or RRC reconfiguration from the network (Node-B and RNC respectively). This set can either be hard-coded in the standard (e.g., all configured secondary serving HS-DSCH cells) or signaled explicitly by the RNC (e.g., via a bitmap). When evaluating whether and in such case which of the active configured secondary serving HS-DSCH cells should be deactivated, the UE monitors the quality of a set of HS-DSCH cells. Note that the monitored set can be different from the set of downlink carriers that the UE can deactivate. This set is referred to as the measured set.

If the quality for one or more of the downlink carriers belonging to the measured set is poor, then the UE deactivates one or more of the secondary serving HS-DSCH cells. For instance, the UE might deactivate all secondary serving HS-DSCH cells in the band where non-adjacent carriers exist. This is shown in FIGS. 3 and 4. FIG. 3 illustrates a non-adjacent carrier configuration for a particular UE, where the two carriers in Band I, f1 and f3, are non-adjacent. Another carrier, f4, in Band II, is also activated. In response to determining that the quality of one or more of the measured set is poor, e.g., as the result of interference from an aggressor carrier falling between carriers f1 and f1, the UE might deactivate f3, as shown in FIG. 4. This approach has the advantage that the UE can now rely on receiver filters (having responses denoted by the bold lines in FIGS. 3 and 4) with smaller bandwidth, and thus the interference leakage from the potential aggressor carrier is marginal.

To measure the downlink quality the UE can use for example: the CQI; the fraction of detected downlink packets (i.e., the proportion of all downlink packets that are properly detected and/or decoded); the fraction of NACKs transmitted (i.e., the ratio of NACKs to all of the ACK/NACK messages received); and/or the quality of the Fractional Dedicated Physical Channel (F-DPCH). The thresholds for each of these could be controlled by and thus known to the network. For example, in a typical scenario the threshold could be controlled by the RNC and known to the serving Node-B.

This technique, by which a UE can deactivate secondary serving HS-DSCH cells without receiving an HS-SCCH order or RRC reconfiguration from the network, has some advantages over methods where the network (e.g., the RNC or Node-B) uses information to decide whether or not a secondary carrier should be deactivated. In particular, this UE-centric approach is more robust with respect to the downlink quality since it does not involve any downlink signaling. Thus, this approach is well-suited for situations where the downlink quality of all carriers is so poor that HS-SCCH orders cannot be received reliably from the serving Node-B.

Deactivating one or more of the downlink carriers may raise further considerations, however. For example, the UE may change its HS-DPCCH format upon deactivating one or more secondary serving HS-DSCH cells. For example, if a UE is configured with Rel-8 DC-HSDPA or Rel-9 DB-DC-HSDPA and the secondary serving HS-DSCH cell is activated, then the UE will combine the two CQI values into one jointly encoded common CQI report, while if the secondary serving HS-DSCH cell is deactivated the UE will revert to CQI encoding according to Release 5 standards.

If the CQIs for each downlink carrier are not encoded in a self-contained way (i.e., the CQIs are jointly encoded), a situation where the Node-B and UE have a different understanding regarding the number of downlink carriers that are activated will result in misinterpreted CQI reports, which can significantly degrade downlink performance. To mitigate the potential effects of this problem, one approach is to avoid the use of HS-DPCCH slot formats where the CQIs are encoded jointly. For instance, the Release 8 DC-HSDPA and Release 9 DB-DC-HSDPA HS-DPCCH slot format can be modified to support non-adjacent carrier operation. Alternatively, the UE can inform the serving Node-B that the UE has deactivated a secondary serving HS-DSCH cell, e.g., by transmitting an all-zero CQI in the position where the CQI of the secondary serving HS-DSCH cell should have been transmitted, i.e., where the CQI for the deactivated carrier would be transmitted if the carrier were activated.

While described above in the context of an HSDPA system, the technique just described is more generally applicable. FIG. 10 illustrates an example method according to some embodiments of the invention more generally. This method is implemented in a user equipment supporting downlink multi-carrier operation. The method begins, as shown at block 1010, with the receiving of a plurality of activated downlink carriers, the activated downlink carriers including, in a frequency band, at least two non-adjacent downlink carriers that are separated by at least one aggressor carrier that the user equipment is not configured to receive. As shown at block 1020, the user equipment monitors quality of at least a subset of the plurality of activated downlink carriers. As seen at block 1030, the user equipment determines that the quality of at least one of the measured set is worse than a predetermined threshold. In response, as shown at block 1040, the user equipment deactivates one or more of the activated downlink carriers.

As suggested earlier, the monitoring of the quality can be based on one or several criteria, such as channel quality indicator (CQI) measurements, a fraction of detected downlink packets (relative to the total downlink packets), a fraction of negative acknowledgements (NACKs) transmitted (relative to all acknowledgements transmitted), and a quality for a fractional dedicated physical channel (F-DPCH).

As noted, the deactivation of a carrier may be triggered by determining that the quality is worse than a predetermined threshold. In some embodiments, this predetermined threshold is received from a network node. In some embodiments, a receiver filter bandwidth is reduced in response to said deactivating, thus reducing the impact of the aggressor carrier on activated carriers.

The carriers monitored by the user equipment may include all or some of the plurality of activated downlink carriers, and thus may or may not include the at least two non-adjacent downlink carriers. In some embodiments, the activated downlink carriers include a set of secondary serving HS-DSCH cells that the user equipment can deactivate without receiving an HS-SCCH order or RRC reconfiguration, and the cell or cells deactivated by the user equipment are members of this set. This set may be all or some of the configured secondary serving HSDSCH cells. In some embodiments, the user equipment may first receive information identifying a set of downlink carriers that can be deactivated, in which case the deactivated downlink carrier or carriers are taken from the identified set.

In some embodiments, the user equipment explicitly signals the network that one or more carriers have been deactivated. For example, the user equipment may transmit an all-zero CQI in a position where CQI for a deactivated carrier would be transmitted if the carrier were activated.

The operations illustrated in the process flow diagram of FIG. 10 may be implemented using radio and processing circuitry provided in the UE. The UE includes suitable radio circuitry for receiving and transmitting radio signals formatted in accordance with known formats and protocols, e.g., Wideband CDMA and HSDPA formats and protocols.

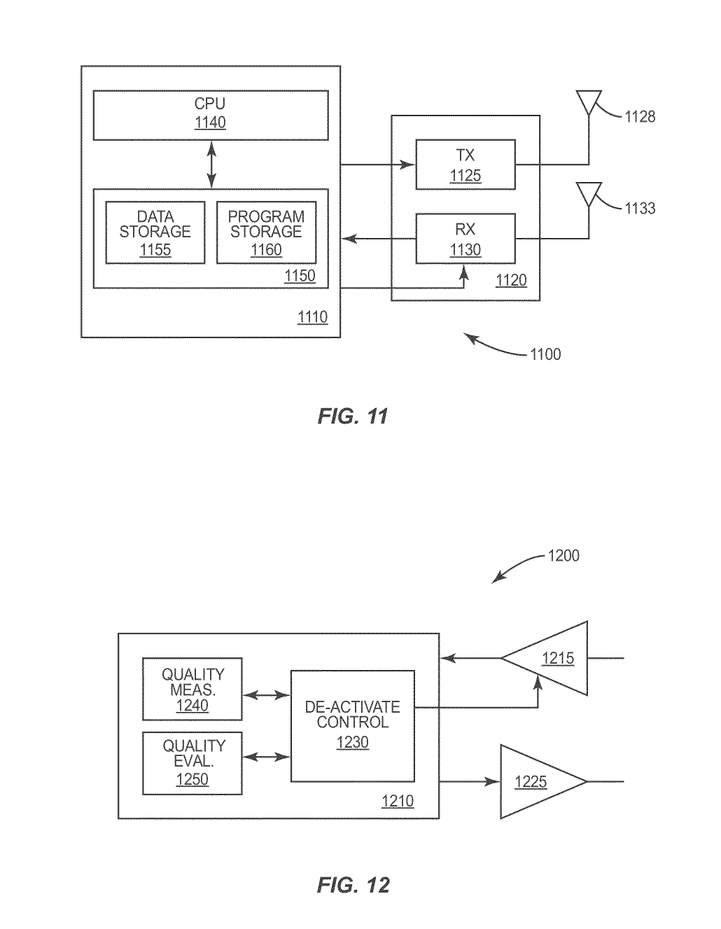

FIG. 11 illustrates features of an example user equipment 1100 according to several embodiments of the present invention. UE 1100 comprises a transceiver 1120 for communicating with one or more base stations as well as a processing circuit 1110 for processing the signals transmitted and received by the transceiver 1120. Transceiver 1120 includes a transmitter 1125 coupled to one or more transmit antennas 1128 and receiver 1130 coupled to one or more receive antennas 1133. The same antenna(s) 1128 and 1133 may be used for both transmission and reception. Receiver 1130 and transmitter 1125 use known radio processing and signal processing components and techniques, typically according to a particular telecommunications standard such as the 3GPP standards for W-CDMA and HSDPA. Because the various details and engineering tradeoffs associated with the design and implementation of such circuitry are well known and are unnecessary to a full understanding of the invention, additional details are not shown here.

Processing circuit 1110 comprises one or more processors 1140, hardware, firmware or a combination thereof, coupled to one or more memory devices 1150 that make up a data storage memory 1155 and a program storage memory 1160. Memory 1150 may comprise one or several types of memory such as read-only memory (ROM), random-access memory, cache memory, flash memory devices, optical storage devices, etc. Again, because the various details and engineering tradeoffs associated with the design of baseband processing circuitry for mobile devices are well known and are unnecessary to a full understanding of the invention, additional details are not shown here.

Typical functions of the processing circuit 1110 include modulation and coding of transmitted signals and the demodulation and decoding of received signals. In several embodiments of the present invention, processing circuit 1110 is adapted, using suitable program code stored in program storage memory 1160, for example, to carry out one of the techniques described above for monitoring the quality of activated downlink carriers, determining that the quality of at least one is worse than a predetermined threshold, and, in response, deactivating one or more of the activated downlink carriers. Of course, it will be appreciated that not all of the steps of these techniques are necessarily performed in a single microprocessor or even in a single module.

FIG. 12 illustrates several functional elements of a user equipment 1200 adapted to carry out some of the techniques discussed in detail above. User equipment 1200 includes a processing circuit 1210 adapted to receive a plurality of activated downlink carriers from a base station, via receiver circuit 1215, the activated downlink carriers including, in a frequency band, at least two non-adjacent downlink carriers that are separated by at least one aggressor carrier that the user equipment is not configured to receive. In several embodiments, processing circuit 1210, which may be constructed in the manner described for the processing circuits 1110 of FIG. 11, includes a quality measurement unit 1240 adapted to monitor quality of at least a subset of the plurality of activated downlink carriers, as well as a quality evaluation unit 1250 adapted to determine whether the quality of at least one of the measured set is worse than a predetermined threshold. Deactivation control unit 1230 then deactivates one or more of the activated downlink carriers, in response to this determination.

While the above discussion focused on a UE-centric approach, it will be appreciated that other approaches are possible. In each of several of these approaches, the quality of the downlink carriers is monitored with the purpose of identifying whether and in such case which secondary downlink carriers (e.g., secondary serving HS-DSCH cells) should be deactivated when some of the configured downlink carriers (e.g., serving or secondary serving HS-DSCH cells) are active and non-adjacent e.g. as shown in 3. In some cases, this monitoring is done by a network node, such as a Node-B or Radio Network Controller (RNC).

For example, to identify these situations the network (Node-B or RNC) may in some cases rely on preexisting information to evaluate the quality of one or more of the configured downlink carriers. The network can monitor quality for one or more of the configured (and active) downlink carriers. In one approach, the network monitors the quality of the carriers configured in a non-adjacent manner in a certain frequency band. This set of evaluated carriers is used to identify whether there is interference leakage (due to the fact that the carriers are non-adjacent), which ensures that activated non-adjacent downlink cells only occur in a band if the quality of all of them is adequate. In another approach the network monitors the quality of all downlink carriers. Measuring the quality of all carriers ensures that the UE only activates non-adjacent carriers if the quality of all downlink carriers is sufficient or, in some cases, that the UE only activates non-adjacent carriers if the quality of at least one downlink carrier is sufficient. In still another related approach, the network monitors the quality of only one of the active downlink carriers (e.g., the serving HS-DSCH cell).

To assess quality for the set of downlink carriers for which performance is measured the network can use various types of information. For instance, the network can use the reported channel quality indicator (CQI). If the CQI of a carrier that is configured in a non-adjacent manner is below a certain value for a certain time-period, this can be viewed as an indicator that the leakage is causing detrimental performance. This information is available at the serving Node-B.

In another approach, the network uses the UE transmit power headroom (UPH) and CQI. The CQI can be combined with the UPH for a certain downlink/uplink pair. While the CQI can be used for identifying the downlink quality, the UPH can be used to compute an estimate of the path gain. This allows the network to remove the effect of the path gain when evaluating the CQI. This information is likewise available at the Node-B.

In yet another approach, the network uses HARQ-ACK information. If the fraction of HARQ-ACK NACKs or HARQ-ACK DTX (instead of HARQ-ACK ACKs) associated with a certain downlink carrier exceeds a threshold, this can be viewed as an indicator that quality of the downlink carrier is inferior. The quality can be specified in terms of an “absolute” level (e.g., 20 percent) or specified with respect to the other active downlink carriers (e.g., 10% percent worse than the second worst carrier). Again, this information is available at the serving Node-B.

In still another approach, the network uses the F-DPCH (Fractional-Dedicated Physical Control Channel) quality. In still another embodiment, the network measures the F-DPCH quality of the downlink carriers associated with an active uplink carrier. If a downlink carrier has bad quality, the UE requests the Node-B to increase the F-DPCH transmit power through DL TPC (Transmit Power Control) commands sent on the associated uplink carrier. Based on this behavior, the Node-B can attempt to estimate the downlink quality from the F-DPCH power level.

Alternatively, or in addition to any of the above techniques, the network uses the uplink DPCCH SIR quality. For the downlink carriers with an associated active uplink carrier, if F-DPCH is poor this will result in a poor uplink (since the UL TPC commands are sent in downlink over this poor F-DPCH). The DPCCH SIR error or the DPCCH BER can be measured in the serving Node-B. This should be conditioned on that the UE is not in SHO.

In yet another approach, the network looks for synchronization problems. If the network observes that a UE configured with non-adjacent carriers seems to be experiencing synchronization problems, radio link failures (RLF) or similar, the network can attempt to configure single-carrier operation or adjacent-carrier operation instead, in order to test whether the synchronization problems disappear.

Each of the measures described above are available at the serving Node-B. Hence, if these metrics are used the method would typically reside in the serving Node-B.

Other approaches involve both the UE and a network node, such as the serving Node-B. For example, in one such approach the UE measures the downlink quality of a set of downlink carriers, where the set could either be pre-determined or signaled by the RNC. If the quality of one or more downlink carriers in the measured set is below a certain quality the UE informs the network (e.g., either the serving Node-B or RNC). This can be accomplished by reusing Layer 1/2 signaling (e.g., CQI, unused MAC header, etc.). If metrics which are only available to the serving Node-B (e.g. CQI) are used, then the serving Node-B should inform the RNC that the serving Node-B has detected this situation so that the RNC can take appropriate action.

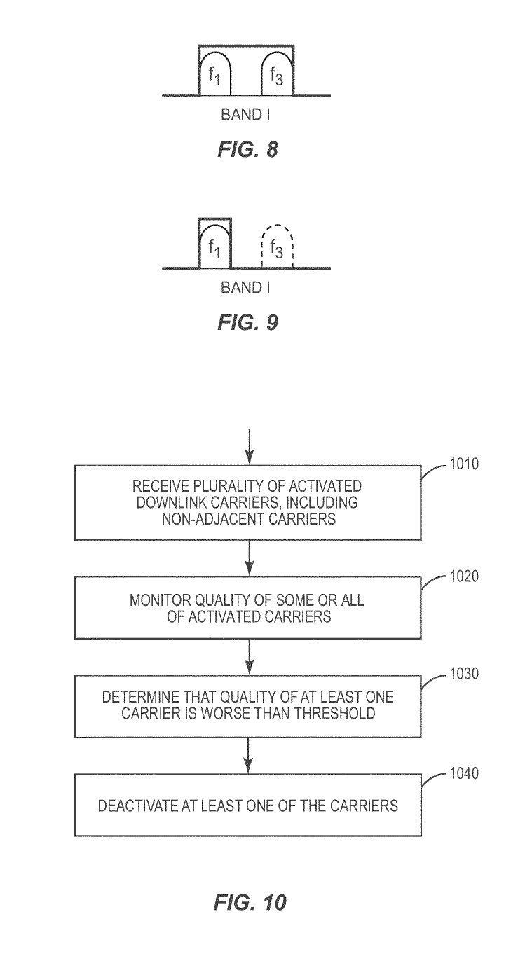

If the network identifies an interference leakage, the so-called ‘Measurement Control’ procedure starts and the RNC sends an inter-frequency measurement message to the particular UE that is experiencing an excessive interference level that is potentially due to an aggressor carrier, e.g., as shown in FIG. 6. The UE sends the measurement report to the RNC. If the receive power of one or more downlink carriers significantly differs from the receive power of the aggressor carrier in the measured set, the RNC can reconfigure the UE, e.g., to single-carrier operation, as can be seen by comparing FIG. 8 and FIG. 9.

Alternatively, a new event can be introduced whereby the RNC is notified that the measured power level associated with the aggressor carrier at the UE exceeds some threshold. This threshold could either be specified in absolute numbers (e.g., Watts of dBm) or in relative numbers (e.g., x dB more power is received from the aggressor carrier as compared to the ‘adjacent’ victim carriers). This approach is based on a method in which the RNC controls which downlink carriers are activated (e.g., in a situation where the UE does not rely on HS-SCCH orders for dynamic activation and deactivation of secondary serving HS-DSCH cells).

Much of the previous discussion relates to activated non-adjacent carriers, and focused on how to detect poor downlink performance in situations where the carriers that were configured in a non-adjacent manner in a band were activated, e.g. as shown in FIG. 3. The discussion that follows addresses the case where there are non-adjacent carriers configured in a band, but where the secondary serving HS-DSCH cells are deactivated so that all activated carriers (or at least all activated carriers within the same band) are adjacent, e.g., as shown in FIG. 4. More specifically, methods are described whereby the serving Node-B and/or the RNC can avoid and/or detect that a performance degradation occurs for carriers when a non-adjacent secondary serving HS-DSCH cell is activated.

In one approach the RNC ensures adequate downlink performance for at least some of the carriers by requiring that the carriers within at least one band are contiguous. One such scenario is illustrated in FIG. 3, where the band in which a single downlink carrier is configured is contiguous in this example. Requiring the carriers within one band to be adjacent ensures that the downlink quality for these carriers remains adequate (even if the activation of the non-adjacent secondary serving HS-DSCH cell in another band yields interference levels so high that outage is achieved for the carriers in that other band). This method resides in the RNC.

In a second approach the serving Node-B conditions its action with respect to activation of secondary serving HS-DSCH cells so that non-contiguous carriers are activated based on historical information. For example, the Node-B may choose to never activate non-contiguous secondary serving HS-DSCH cells for certain sets of cells (i.e. consisting of certain cells). Moreover, the RNC can build up knowledge about which UE configurations for non-adjacent multi-carrier operation cause problems at a particular Node-B or in a particular geographical area, and try to avoid altogether configuring UEs in this way in this Node-B or area.

A third approach addresses a scenario in which the UE only has adjacent carriers configured in the band(s), e.g., as shown in FIG. 9, but where the RNC can configure additional serving HS-DSCH cells via RRC and the resulting configuration results in a setting where some of the active downlink carriers in at least one of the band are non-adjacent, e.g., as shown in FIG. 8. In order for the RNC to know whether or not a reconfiguration to a configuration resulting in non-adjacent activated downlink carriers is suitable, it is beneficial to know the interference level caused by the (potential) aggressor carrier. For this purpose the RNC can request the UE to perform the inter-frequency measurement for other than the configured carriers within a band. For example, if the UE is configured with f1 but the network is capable of also transmitting downlink data on f4 in a certain band, the RNC can request measurements also for f2 and f3. Based on these measurements the UE and/or RNC can estimate the interference level based on relative difference in received power between the configured carrier in the band and the (potential) aggressor carrier (if the UE is reconfigured so that the activated carriers in the band are non-adjacent). The measurements can also be done periodically to evaluate whether to reconfigure to non-adjacent multi-carrier operation or not. This method resides in the UE and RNC.

In a fourth approach, the default activation status of secondary serving HS-DSCH cells on non-adjacent downlink carriers is ‘deactivated’ rather than ‘activated’, and the serving Node-B uses HS-SCCH orders in order to activate them. For the downlink multi-carrier features specified in Rel-8/9/10, the default activation status is ‘activated’, i.e. when the RNC configures a UE for downlink multi-carrier operation, the secondary serving HS-DSCH cells immediately becomes activated, before the serving Node-B has a chance to use any HS-SCCH orders. This approach can improve the robustness since the serving Node-B may have better knowledge of radio conditions compared to the RNC. The serving Node-B may then choose to activate the non-adjacent carrier(s) upon determining it is a good time to do so (e.g., only when the CQI for the serving HS-DSCH cell is judged as good enough). If the serving Node-B experiences that the radio conditions for the UE drops significantly after the non-adjacent carrier(s) have been activated, the serving Node-B can respond to this situation by sending another HS-SCCH order to deactivate the non-adjacent carrier(s). This method resides in the serving Node-B.

An enhancement to this fourth approach includes the UE performing a judgment of whether the experienced radio conditions have deteriorated significantly after the activation of the non-adjacent carrier(s) compared to before the activation. If so the UE can autonomously deactivate the non-adjacent carrier(s). The judgment can for example be based on the CQI of the serving HS-DSCH cell before and after the activation. This method is also applicable in the case where the initial status of configured serving HS-DSCH cell(s) is active.

An additional enhancement of this approach includes the UE performing this judgment before it is time to transmit the HS-DPCCH ACK to the serving Node-B which indicates the UE's acknowledgement of the HS-SCCH order. If the result of the judgment is that the non-adjacent carrier(s) should be deactivated, the UE can indicate this to the serving Node-B by transmitting a NACK instead of an ACK, or alternatively by not transmitting anything (neither an ACK nor a NACK).

It will be appreciated by the person of skill in the art that various modifications may be made to the above described embodiments without departing from the scope of the present invention. For example, it will be readily appreciated that although the above embodiments are described with reference to parts of a 3GPP network, an embodiment of the present invention will also be applicable to like networks, such as a successor of the 3GPP network, having like functional components. Therefore, in particular, the terms 3GPP and associated or related terms used in the above description and in the enclosed drawings and any appended claims now or in the future are to be interpreted accordingly.

Examples of several embodiments of the present invention have been described in detail above, with reference to the attached illustrations of specific embodiments. Because it is not possible, of course, to describe every conceivable combination of components or techniques, those skilled in the art will appreciate that the present invention can be implemented in other ways than those specifically set forth herein, without departing from essential characteristics of the invention. The present embodiments are thus to be considered in all respects as illustrative and not restrictive.

1-33. (canceled)

34. A method implemented in a user equipment supporting downlink multi-carrier operation, the method comprising receiving a plurality of activated downlink carriers, the activated downlink carriers including, in a frequency band, at least two non-adjacent downlink carriers that are separated by at least one aggressor carrier that the user equipment is not configured to receive, the method further comprising:
monitoring quality of at least a subset of the plurality of activated downlink carriers, the monitored downlink carriers defining a measured set;
determining that the quality of at least one of the measured set is worse than a predetermined threshold; and,
in response to said determining, deactivating one or more of the activated downlink carriers.

35. The method of claim 34, wherein said monitoring quality is based on, for one or more carriers of the measured set, one or more of:
Channel Quality Indicator (CQI) measurements;
a fraction of detected downlink packets;
a fraction of negative acknowledgements (NACKs) transmitted; and
a quality for a fractional dedicated physical channel (F-DPCH).

36. The method of claim 34, further comprising first receiving said predetermined threshold from a network node.

37. The method of claim 34, further comprising reducing a receiver filter bandwidth in response to said deactivating.

38. The method of claim 34, wherein the measured set includes the at least two non-adjacent downlink carriers.

39. The method of claim 34, further comprising signaling the network that one or more carriers has been deactivated.

40. The method of claim 39, wherein said signaling comprises transmitting an all-zero Channel Quality Indicator (CQI) in a position where CQI for a deactivated carrier would be transmitted if the carrier were activated.

41. The method of claim 34, further comprising first receiving information identifying a set of downlink carriers that can be deactivated, wherein said deactivating one or more of the activated downlink carriers comprises deactivating only downlink carriers from the identified set.

42. The method of claim 34, wherein the activated downlink carriers include a set of secondary serving High-Speed Downlink Shared Channel (HS-DSCH) cells that the user equipment can deactivate without receiving an High-Speed Shared Control Channel (HS-SCCH) order or Radio Resource Control (RRC) reconfiguration and wherein said deactivating comprises deactivating one or more of the cells in said set of secondary serving HS-DSCH cells.

43. The method of claim 42, wherein the set of secondary serving HS-DSCH cells comprises all configured secondary serving HS-DSCH cells.

44. The method of claim 42, the method further comprising first receiving signaling information that identifies the set of secondary serving HS-DSCH cells that the user equipment can deactivate without receiving an HS-SCCH order or RRC reconfiguration.

45. A user equipment adapted to support downlink multi-carrier operation, the user equipment comprising a receiver circuit adapted to receive a plurality of activated downlink carriers, the activated downlink carriers including, in a frequency band, at least two non-adjacent downlink carriers that are separated by at least one aggressor carrier that the user equipment is not adapted to receive, the user equipment further comprising a processing circuit adapted to:
monitor quality of at least a subset of the plurality of activated downlink carriers, the monitored downlink carriers defining a measured set;
determine that the quality of at least one of the measured set is worse than a predetermined threshold; and
deactivate one or more of the activated downlink carriers, in response to said determining.

46. The user equipment of claim 45, wherein the processing circuit is adapted to monitor quality based on, for one or more carriers of the measured set, one or more of:
Channel Quality Indicator (CQI) measurements;
a fraction of detected downlink packets;
a fraction of negative acknowledgements (NACKs) transmitted; and
a quality for a fractional dedicated physical channel (F-DPCH).

47. The user equipment of claim 45, wherein the processing circuit is further adapted to first receive said predetermined threshold from a network node.

48. The user equipment of claim 45, wherein the processing circuit is further adapted to reduce a receiver filter bandwidth in response to said deactivating.

49. The user equipment of claim 45, wherein the measured set includes the at least two non-adjacent downlink carriers.

50. The user equipment of claim 45, wherein the user equipment further comprises a transmitter circuit adapted to signal the network that one or more carriers has been deactivated.

51. The user equipment of claim 50, wherein the transmitter circuit is adapted to signal the network that one or more carriers has been deactivated by transmitting an all-zero CQI in a position where CQI for a deactivated carrier would be transmitted if the carrier were activated.

52. The user equipment of claim 45, wherein the processing circuit is further adapted to first receive information identifying a set of downlink carriers that can be deactivated, and wherein the processing circuit is adapted to deactivate only downlink carriers from the identified set.

53. The user equipment of claim 45, wherein the activated downlink carriers include a set of secondary serving High-Speed Downlink Shared Channel (HS-DSCH) cells that the user equipment can deactivate without receiving an High-Speed Shared Control Channel (HS-SCCH) order or Radio Resource Control (RRC) reconfiguration and wherein the processing circuit is adapted to deactivate one or more of the cells in said set of secondary serving HS-DSCH cells.

54. The user equipment of claim 53, wherein the set of secondary serving HS-DSCH cells comprises all configured secondary serving HS-DSCH cells.

55. The user equipment of claim 53, wherein the processing circuit is further adapted to first receive signaling information that identifies the set of secondary serving HS-DSCH cells that the user equipment can deactivate without receiving an HS-SCCH order or RRC reconfiguration.
